(19) United States
(12) Patent Application Publication
(10) Pub. No.: US 2003/0018774 A1
(43) Pub. Date: Jan. 23, 2003

(54) System and method for load balancing in ad hoc networks

(75) Inventors: Hannu Flinck, San Jose, CA (US); Lars Anders Nilsson, Nodinge (SE)

Correspondence Address: MERCHANT & GOULD PC, P.O. BOX 2903, MINNEAPOLIS, MN, 55402-0903, US

(73) Assignee: Nokia Corporation, Espoo (FI)

(21) Appl. No.: 10/171,454

(22) Filed: Jun. 12, 2002

Related U.S. Application Data
(60) Provisional application No. 60/298,462, filed on Jun. 13, 2001.

(51) Int. Cl. G06F 15/173

(52) U.S. Cl. 709/223; 709/105

(57) ABSTRACT

A method and system for load balancing in ad hoc networks. An ad hoc node stores address information associated with a gateway that provides a communication path between an ad hoc network and another network. When other ad hoc nodes request the address information from the gateway, an ad hoc node through which the request passes may respond by providing the information. This allows responding to requests for address information to be load balanced over the nodes of an ad hoc network.

### RELATED APPLICATION

This application is a Utility Patent application based on a previously filed U.S. Provisional Patent application, U.S. Serial No. 60/298,462 filed on Jun. 13, 2001, the benefit of the filing date of which is hereby claimed under 35 U.S.C. §119(e).

### FIELD OF THE INVENTION

The present invention relates generally to ad hoc networks, and in general to load balancing in ad hoc networks.

### BACKGROUND

Ad hoc networking has been designed for dynamic environments where the network may be changing constantly. In doing so, many of the Internet routing protocols have been replaced with new types of ad hoc routing protocols. Even in such an ad hoc networking scenario, there is a frequent need for hosts to access services in the wired Internet. Consequently, some nodes act as gateways between the ad hoc network and the Internet.

When an ad hoc node needs to communicate with the Internet, it locates a gateway between the ad hoc network and the Internet. Locating the gateway typically involve some kind of signaling between the gateway and the ad hoc node that wants to communicate over the Internet using the gateway. In addition, traffic between the ad hoc node and the Internet travels through the gateway. When one or more ad hoc nodes use the same gateway extensively, the signaling to find the gateway and the actual traffic transmitted to the gateway may cause the bandwidth of the air interface of the gateway to become very congested. Thus, there is a need to offload the gateway and its related air interface from messaging or signals that can be handled elsewhere.

### SUMMARY

In accordance with the present invention, there is provided a method and system for load balancing in ad hoc networks. An ad hoc node stores address information associated with a gateway that provides a communication path between the ad hoc network and another network. When other ad hoc nodes request the address information from the gateway, an ad hoc node through which the request passes may respond by providing the information. This allows responding to requests for address information to be load balanced over the nodes of an ad hoc network.

In one aspect of the invention, the address information may include a route that indicates a path to the gateway. This may be used, for example, to respond to a node that sends a route discovery request to determine a route to a gateway. The routing information may be used to route messages to the gateway to be sent to the other network.

In another aspect of the invention, the address information may include a portion of an address associated with the gateway that identifies the ad hoc network to a node in another network. The portion of the address may be used to create a unique address that identifies the ad hoc node. This unique address may then be sent to a forwarding node in the ad hoc node's home network. This allows an ad hoc node to have the forwarding node forward messages to the ad hoc node. The unique address may be created by concatenating a sequence of bits to the portion of the address.

In another aspect of the invention, a system for load balancing in an ad hoc network includes a gateway and a first and second ad hoc nodes. The gateway provides a communication path between the ad hoc network and another network, such as the Internet. The first ad hoc node stores address information that is associated with the gateway and supplies it to the second ad hoc node when it receives a request. The second ad hoc node sends a request for the address information by sending a message addressed to the gateway. It then employs the address information it receives to form an address that identifies the second ad hoc node.

In another aspect of the invention, a second ad hoc node employs at least a first ad hoc node when sending a message to the gateway. Each node in an ad hoc network may communicate with other nodes in the ad hoc network over a wireless communication medium. The gateway may communicate with another network over a non-wireless communication medium while communicating with ad hoc nodes over a wireless communication medium. The ad hoc network and the other network behind the gateway typically have different address spaces. When an ad hoc node wishes to use the gateway to communicate with a node in the other network, the ad hoc node needs an address from the other address space as well. A gateway that is attached to both networks can supply the ad hoc node with a full or partial address from the other network to be used for this communication.

In another aspect of the invention, when responding to a request for address information, a flag may be set that indicates whether a gateway or an ad hoc node is responding.

These and various other features as well as advantages, which characterize the present invention, will be apparent from a reading of the following detailed description and a review of the associated drawings.

### BRIEF DESCRIPTION OF THE DRAWINGS

FIGS. 1-2 show components of an exemplary environment in which the invention may be practiced;

FIG. 3 illustrates an exemplary environment in which a system for load balancing in ad hoc networks operates; and

FIG. 4 illustrates a flow chart for load balancing in an ad hoc in accordance with the invention.

### DETAILED DESCRIPTION

In the following detailed description of exemplary embodiments of the invention, reference is made to the accompanied drawings, which form a part hereof, and which are shown by way of illustration, specific exemplary embodiments of which the invention may be practiced. These embodiments are described in sufficient detail to enable those skilled in the art to practice the invention, and it is to be understood that other embodiments may be utilized, and other changes may be made, without departing from the spirit or scope of the present invention. The following detailed description is, therefore, not to be taken in a limiting sense, and the scope of the present invention is defined by the appended claims.

In the following description, first definitions of some terms that are used throughout this document are given. Then, illustrative components of an illustrative operating environment in which the invention may be practiced are disclosed. Next, a system for load balancing in ad hoc networks is disclosed. Finally, a method for load balancing in ad hoc networks is provided.

Definitions

The definitions in this section apply to this document, unless the context clearly indicates otherwise. The phrase “this document” means the specification, claims, and abstract of this application.

“Including” and its variants mean including but not limited to. Thus, a list including A is not precluded from including B.

A “packet” includes to an arbitrary or selectable amount of data which may be represented by a sequence of one or more bits. A packet may correspond to a data unit found in any layer of the Open Systems Interconnect (OSI) model, such as a segment, message, packet, datagram, frame, symbol stream, or stream, a combination of data units found in the OSI model, or a non OSI data unit.

A “message” includes one or more packets. A message has a particular semantic that is associated with the context in which the message is used.

Referring to the drawings, like numbers indicate like parts throughout the figures and this document.

Definitions of terms are also found throughout this document. These definitions need not be introduced by using “means” or “refers” to language and may be introduced by example and/or function performed. Such definitions will also apply to this document, unless the context clearly indicates otherwise.

Illustrative Operating Environment

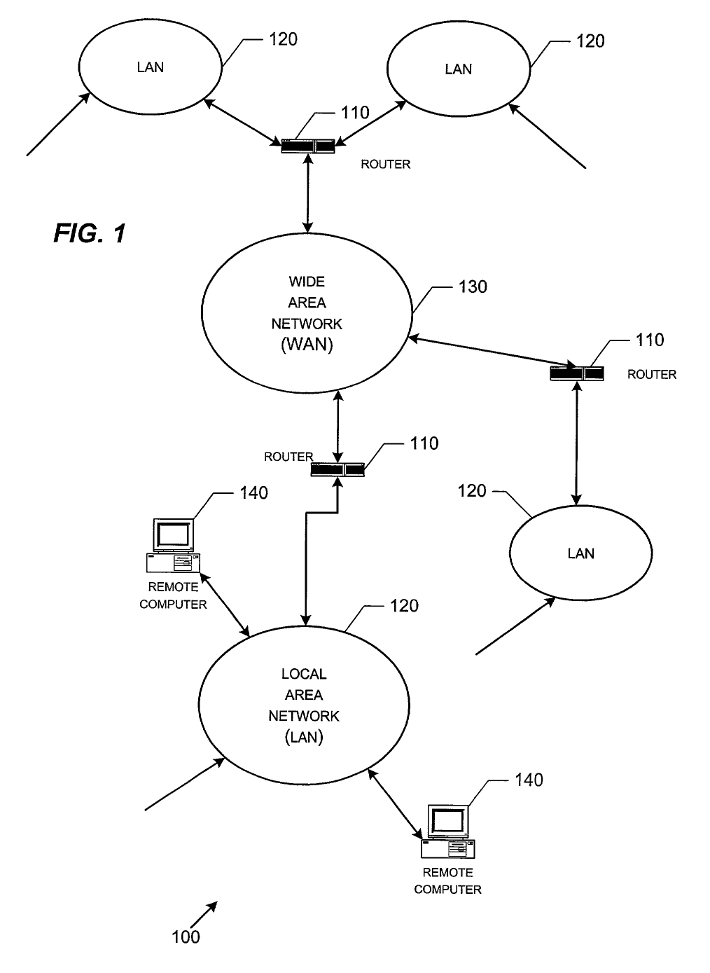

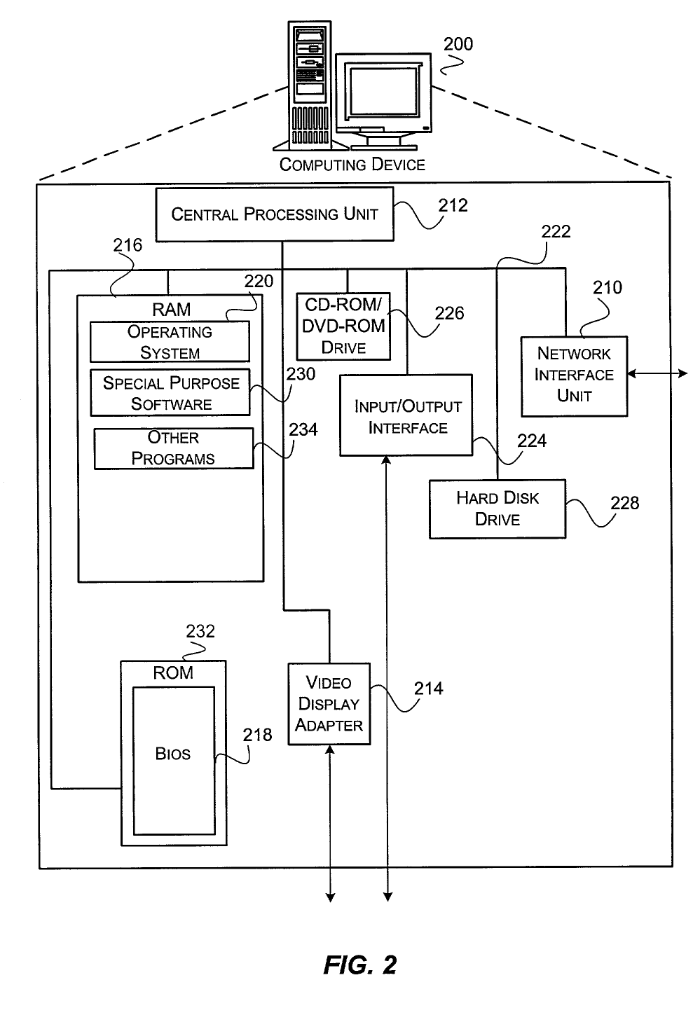

FIGS. 1-2 show components of an exemplary environment in which the invention may be practiced. Not all the components may be required to practice the invention, and variations in the arrangement and type of the components may be made without departing from the spirit or scope of the invention.

FIG. 1 shows a plurality of local area networks (“LANs”) 120 and wide area network (“WAN”) 130 interconnected by routers 110. Routers 110 are intermediary devices on a communications network that expedite packet delivery. On a single network linking many computers through a mesh of possible connections, a router receives transmitted packets and forwards them to their correct destinations over available routes. On an interconnected set of LANs—including those based on differing architectures and protocols—, a router acts as an interface between LANs, enabling packets to be sent from one to another. A router may be implemented using special purpose hardware, a computing device executing appropriate software, such as computing device 200 as described in conjunction with FIG. 2, or through any combination of the above.

In an embodiment of the invention, a LAN includes nodes that communicate with each other using an ad hoc routing protocol. The use of the ad hoc routing protocol and its addressing scheme is invisible to the other network.

Communication links within LANs typically include twisted pair, fiber optics, coaxial cable, or any wireless technologies such as IEEE 802.11, while communication links between networks may utilize analog telephone lines, full or fractional dedicated digital lines including T1, T2, T3, and T4, Integrated Services Digital Networks (ISDNs), Digital Subscriber Lines (DSLs), wireless links, or other communications links known to those skilled in the art. Furthermore, computers, such as remote computer 140, and other related electronic devices can be remotely connected to either LANs 120 or WAN 130 via a network connection. The number of WANs, LANs, and routers in FIG. 1 may be increased or decreased arbitrarily without departing from the spirit or scope of this invention.

As such, it will be appreciated that the Internet itself may be formed from a vast number of such interconnected networks, computers, and routers. Generally, the term “Internet” refers to the worldwide collection of networks, gateways, routers, and computers that use the Transmission Control Protocol/Internet Protocol (“TCP/IP”) suite of protocols to communicate with one another. At the heart of the Internet is a backbone of high-speed data communication lines between major nodes or host computers, including thousands of commercial, government, educational, and other computer systems, that route data and packets. An embodiment of the invention may be practiced over the Internet without departing from the spirit or scope of the invention.

The media used to transmit information in communication links as described above illustrates one type of computer-readable media, namely communication media. Generally, computer-readable media includes any media that can be accessed by a computing device. Computer-readable media may include computer storage media, communication media, or any combination thereof.

Communication media typically embodies computer-readable instructions, data structures, program modules, or other data in a modulated data signal such as a carrier wave or other transport mechanism and includes any information delivery media. By way of example, communication media includes wired media such as twisted pair, coaxial cable, fiber optics, wave guides, and other wired media and wireless media such as acoustic, RF, infrared, and other wireless media.

The Internet has recently seen explosive growth by virtue of its ability to link computers located throughout the world. As the Internet has grown, so has the WWW. Generally, the WWW is the total set of interlinked hypertext documents residing on HTTP (hypertext transport protocol) servers around the world. Documents on the WWW, called pages or Web pages, are typically written in HTML (Hypertext Markup Language) or some other markup language, identified by URLs (Uniform Resource Locators) that specify the particular machine and pathname by which a file can be accessed, and transmitted from server to end user using HTTP. Codes, called tags, embedded in an HTML document associate particular words and images in the document with URLs so that a user can access another file, which may literally be halfway around the world, at the press of a key or the click of a mouse. These files may contain text (in a variety of fonts and styles), graphics images, movie files, media clips, and sounds as well as Java applets, ActiveX controls, or other embedded software programs that execute when the user activates them. A user visiting a Web page also may be able to download files from an FTP site and send packets to other users via email by using links on the Web page.

A computing device that may provide a WWW site is described in more detail in conjunction with FIG. 2. When used to provide a WWW site, such a computing device is typically referred to as a WWW server. A WWW server is a computing device connected to the Internet having storage facilities for storing hypertext documents for a WWW site and running administrative software for handling requests for the stored hypertext documents. A hypertext document normally includes a number of hyperlinks, i.e., highlighted portions of text which link the document to another hypertext document possibly stored at a WWW site elsewhere on the Internet. Each hyperlink is associated with a URL that provides the location of the linked document on a server connected to the Internet and describes the document. Thus, whenever a hypertext document is retrieved from any WWW server, the document is considered to be retrieved from the WWW. As is known to those skilled in the art, a WWW server may also include facilities for storing and transmitting application programs, such as application programs written in the JAVA programming language from Sun Microsystems, for execution on a remote computer. Likewise, a WWW server may also include facilities for executing scripts and other application programs on the WWW server itself.

FIG. 2 shows a computing device. Such a device may be used, for example, as a server, workstation, network appliance, router, bridge, firewall, gateway, and/or as a traffic management device. When used to provide a WWW site, computing device 200 transmits WWW pages to the WWW browser application program executing on requesting devices to carry out this process. For instance, computing device 200 may transmit pages and forms for receiving information about a user, such as address, telephone number, billing information, credit card number, etc. Moreover, computing device 200 may transmit WWW pages to a requesting device that allows a consumer to participate in a WWW site. The transactions may take place over the Internet, WAN/LAN 100, or some other communications network known to those skilled in the art.

It will be appreciated that computing device 200 may include many more components than those shown in FIG. 2. However, the components shown are sufficient to disclose an illustrative environment for practicing the present invention. As shown in FIG. 2, computing device 200 may be connected to WAN/LAN 100, or other communications network, via network interface unit 210. Network interface unit 210 includes the necessary circuitry for connecting computing device 200 to WAN/LAN 100, and is constructed for use with various communication protocols including the TCP/IP protocol. Network interface unit 210 may include or interface with circuitry and components for transmitting messages and data over a wired and/or wireless communications medium. Typically, network interface unit 210 is a card contained within computing device 200.

Computing device 200 may also include processing unit 212, video display adapter 214, and a mass memory, all connected via bus 222. The mass memory generally includes random access memory (“RAM”) 216, read-only memory (“ROM”) 232, and one or more permanent mass storage devices, such as hard disk drive 228, a tape drive (not shown), optical drive 226, such as a CD-ROM/DVD-ROM drive, and/or a floppy disk drive (not shown). The mass memory stores operating system 220 for controlling the operation of computing device 200. It will be appreciated that this component may comprise a general purpose operating system including, for example, UNIX, LINUX™, or one produced by Microsoft Corporation of Redmond, Wash. Basic input/output system (“BIOS”) 218 is also provided for controlling the low-level operation of computing device 200.

The mass memory as described above illustrates another type of computer-readable media, namely computer storage media. Computer storage media may include volatile and nonvolatile, removable and non-removable media implemented in any method or technology for storage of information, such as computer readable instructions, data structures, program modules or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory may also store program code and data for providing a WWW site. More specifically, the mass memory may store applications including special purpose software 230, and other programs 234. Special purpose software 230 may include a WWW server application program that includes computer executable instructions which, when executed by computing device 200, generate WWW browser displays, including performing the logic described above. Computing device 200 may include a JAVA virtual machine, an SMTP handler application for transmitting and receiving email, an HTTP handler application for receiving and handing HTTP requests, JAVA applets for transmission to a WWW browser executing on a client computer, and an HTTPS handler application for handling secure connections. The HTTPS handler application may be used for communication with an external security application to send and receive sensitive information, such as credit card information, in a secure fashion.

Computing device 200 may also comprise input/output interface 224 for communicating with external devices, such as a mouse, keyboard, scanner, or other input devices not shown in FIG. 2. In some embodiments of the invention, computing device 200 does not include user input/output components. For example, computing device 200 may or may not be connected to a monitor. In addition, computing device 200 may or may not have video display adapter 214 or input/output interface 224. For example, computing device 200 may implement a network appliance, such as a router, gateway, traffic management device, etc., that is connected to a network and that does not need to be directly connected to user input/output devices. Such a device may be accessible, for example, over a network.

Computing device 200 may further comprise additional mass storage facilities such as optical drive 226 and hard disk drive 228. Hard disk drive 228 is utilized by computing device 200 to store, among other things, application programs, databases, and program data used by a WWW server application executing on computing device 200. A WWW server application may be stored as special purpose software 230 and/or other programs 234. In addition, customer databases, product databases, image databases, and relational databases may also be stored in mass memory or in RAM 216.

As will be recognized from the discussion below, aspects of the invention may be embodied on routers 110, on computing device 200, on a gateway, on other devices, such as ad hoc nodes, or on some combination of the above. For example, programming steps used in load balancing in an ad hoc network may be included in special purpose software 230 and/or other programs 234 on an ad hoc node.

Exemplary Configuration of System for Load Balancing in Ad Hoc Networks

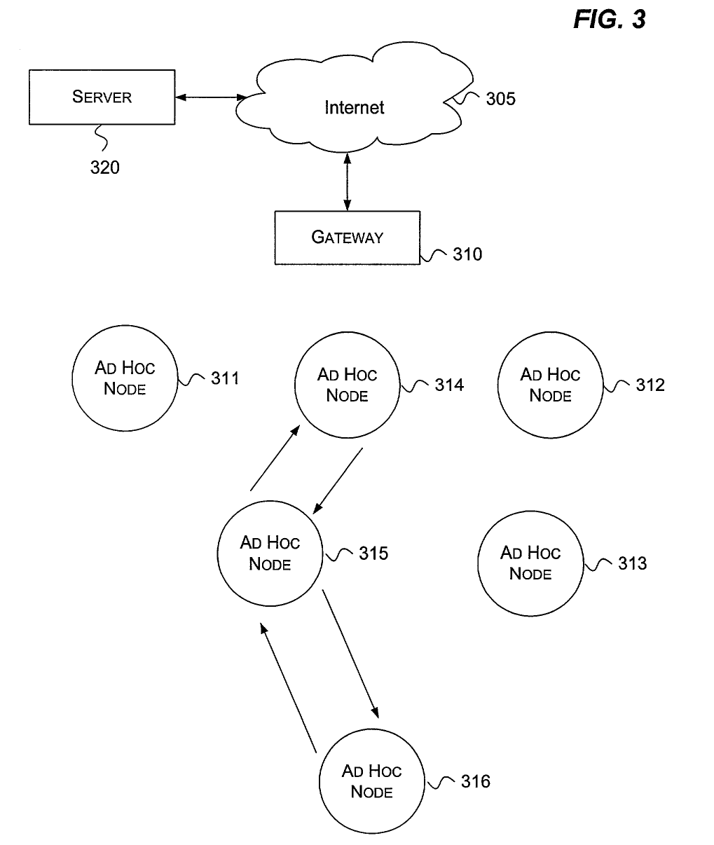

FIG. 3 illustrates an exemplary environment in which a system for load balancing in ad hoc networks operates, according to one embodiment of the invention. The system includes Internet 305, gateway 310, ad hoc nodes 311-316, and server 320. Gateway 310 is coupled to Internet 305 over a communication medium. Ad hoc nodes 311-316 communicate with gateway 310 and with each other over a wireless communication medium. Server is also coupled to Internet 305 over a communication medium. In another embodiment of the invention, some of ad hoc nodes 311-316 communicate with gateway 310 and/or each other over a non-wireless communication medium. Ad hoc nodes 311-316 form a network (hereinafter “the ad hoc network”).

Internet 305 includes any network that can be connected to gateway 310. Such a network may be a WAN, LAN, phone network, wireless network, other networks as known by those skilled in the art, or any combination thereof. Internet 305 may be the Internet as that term has been defined above. An exemplary network that may be used to implement Internet 305 is WAN/LAN 100 of FIG. 1.

Gateway 310 may be implemented using any device capable of communicating with Internet 305 and ad hoc nodes 311-316. In one embodiment of the invention, gateway 310 includes a wired link to Internet 305 and a wireless link to ad hoc nodes 311-316. In another embodiment of the invention, gateway includes a wireless link to Internet 305 and may include wired and/or wireless links to one or more of ad hoc nodes 311-316. Gateway 310 may be implemented on a router, such as router 110 of FIG. 1. In another embodiment of the invention, gateway 310 is an ad hoc node capable of communicating with Internet 305. Gateway 310 provides a communication path between ad hoc nodes 311-316 and Internet 305. It may translate between protocols used by ad hoc nodes 311-316 and Internet 305 when needed. Generally, gateway 310 forwards packets between network interfaces and runs routing protocols that announce reachability information in terms of addresses.

Gateway 310 may include or transmit an address that uniquely identifies the subnetwork that runs ad hoc routing and/or the gateway. Hereinafter this address is sometimes referred to as an address associated with the ad hoc network or an address associated with the gateway. Alternatively, or in addition, gateway 310 may include or transmit a portion of an address (hereinafter “prefix”) that uniquely identifies the ad hoc network and/or gateway. Hereinafter, references to this address refer to a complete address identifying the ad hoc network and/or gateway or a prefix identifying the ad hoc network and/or gateway. This address may allow, for example, a node in Internet 305, such as server 320, to communicate with a node in the ad hoc network. Gateway 310 may provide this address to a requesting ad hoc node so that the requesting ad hoc node may configure its address. The address from the gateway is primarily meant for communication between the ad hoc node and other nodes located on a network other than the ad hoc network. The address may also be used, however, for communication internal to the ad hoc network as well. After this, the ad hoc node can be uniquely reachable from the Internet. Such an address may be configured using Internet Protocol, Version 6 (IPv6), Internet Protocol, Version 4 (IPv4), ad hoc on-demand distance vector routing (AODV), and/or another protocol. A computing device, such as computing device 200, configured with a network interface unit capable of wireless and wired network communication and appropriate special purpose software may be used to implement gateway 310.

Ad hoc nodes 311-316 are devices capable of connecting with gateway 310 and/or each other. Generally, the set of such devices includes devices that typically connect using a wireless communications medium such as cell phones, smart phones, pagers, walkie talkies, radio frequency (RF) devices, infrared (IR) devices, CBs, integrated devices combining one or more of the preceding devices, and the like. In addition, the set of such devices may also include devices that typically connect using a wired communications medium such as personal computers, multiprocessor systems, microprocessor-based or programmable consumer electronics, network PCs, and the like. Some ad hoc nodes may be capable of connecting to gateway 310 using a wired or wireless communication medium, e.g., a PDA, POCKET PC, wearable computer, or other device mentioned above that is equipped to use a wired and/or wireless communications medium. A device that may be used to implement an ad hoc node is computing device 200 of FIG. 2 configured with the appropriate hardware and/or software.

Typically, an ad hoc node is a portable device that runs ad hoc routing protocols. Most often, an ad hoc node has at least a wireless interface for communicating with other nodes (although it may also have a wired interface). An ad hoc node may act as a host and/or router. Ad hoc nodes can communicate with each other and forward traffic from each other to the right destination as guided by ad hoc routing protocols, such as the AODV protocol.

Each ad hoc node may also be capable of acting as a router for packets sent from other ad hoc nodes. In this role, an ad hoc node forwards packets it receives that are not destined to it. An ad hoc node may learn of the presence of another node by receiving a packet such as a Hello message and/or route request/route reply of the AODV protocol from another ad hoc node or gateway 310.

An ad hoc node may be one or more hops away from gateway 310. The number of hops from an ad hoc node to a gateway is the number of communication links the message travels through to get to the gateway. Therefore, assuming that ad hoc nodes 311, 312, and 314 communicate directly with gateway 310, these nodes would be one hop from gateway 310. (A message transmitted from ad hoc node 314 to gateway 310 would only pass through one communication link to get to gateway 310.) The distance from the gateway could be concluded by the reception of Hello messages from the gateway or by other messages that indicate the hop count as a measure for distance from the gateway, such as link local router advertisements. If ad hoc nodes 315 and 313 had to communicate through one of ad hoc nodes 311, 312, and 314 to send a message to gateway 310, these nodes would be two hops from gateway 310. If ad hoc node 316 had to communicate through ad hoc node 315 (which had to communicate through ad hoc node 314) to reach gateway 310, ad hoc node 316 would be three hops from gateway 310.

When an ad hoc node attempts to become part of an ad hoc network, the ad hoc node typically needs to establish an address at which it can be reached in the ad hoc network. This address needs to be unique only within the ad hoc network and in a typical setting is unreachable from an external network. After establishing this address, the ad hoc node may send the address to a forwarding node coupled to the Internet. For example, the ad hoc node may have a “home” network, i.e., a network at which it is normally connected or which is designated as the ad hoc node's home network. This network may have a forwarding node that receives messages directed to the node at its home network and forwards them to an ad hoc network to which the node is currently connected.

When the ad hoc node attaches to a new ad hoc network, the ad hoc node needs to inform the forwarding node of an address at which it can be found. To form this address, the ad hoc node may use an address that has been assigned to the ad hoc network and that is available from the gateway. To obtain this address, the ad hoc node may initiate a route discovery request message (RREQ) to determine a route to the gateway. A node that knows a route to the gateway may respond to the RREQ with a route reply (RREP) including the route. If a gateway itself responds to the RREQ, the gateway may set a flag in the response that indicates that the response came from the gateway. The ad hoc node may be able to set a flag in its request that requires that the gateway respond to the RREQ instead of another node. After it has obtained a route to the gateway, the ad hoc node may then request an address associated with the gateway by sending a message addressed to the gateway.

The above address discovery mechanism above may be improved by including an address associated with the gateway in a RREP sent from the gateway. Instead of just responding with a route to a gateway, the gateway could respond with both a route to the gateway and an address that identifies the ad hoc network.

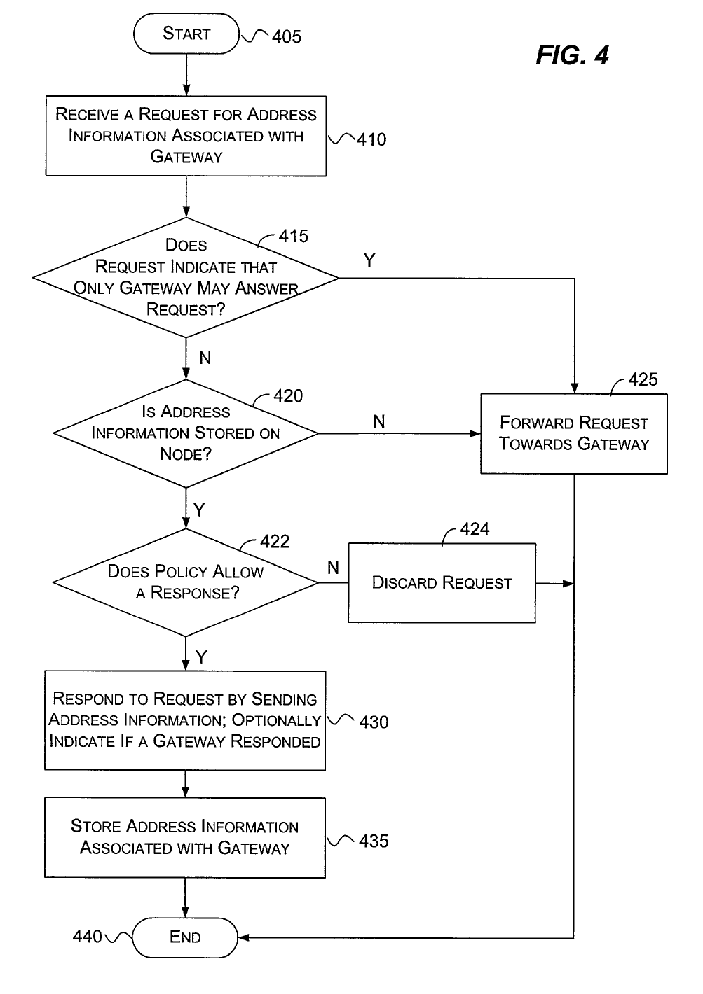

Having the gateway respond to each RREQ and address request may consume the bandwidth of a communications medium surrounding the gateway. In an embodiment of the invention, ad hoc nodes may respond to a request for an address identifying the ad hoc network and/or a RREQ. For example, a gateway may send address information in periodic advertisements that include routing information and/or an address associated with the gateway to ad hoc nodes that are at least one hop from the gateway. These nodes may use this address information to update, among other things, a computer storage medium storing the address information. When one of these nodes receives a request for the address information, it may send a message that includes the address information to the requestor. The node may set a flag in its response to indicate that the response comes from a node other than the gateway. Other nodes more than one hop from the gateway may also store the address information. Upon receipt of a request, each of these other nodes may respond to a request for the address information. A parameter may be configured that allows ad hoc nodes within N hops of a gateway to respond to requests for the address information. A process that provides address information associated with the ad hoc network and/or gateway to requesting nodes is illustrated in FIG. 4.

Server 320 may be a WWW server or some other device coupled to Internet 305. Typically, server 320 will have a permanent address and a name. Configured as a WWW server or other content server, server 320 may provide content to requesters. As such, one of ad hoc nodes 311-316 may desire to obtain content from server 320. An ad hoc node may do so by sending a request addressed to server 320. This request may pass through gateway 310 and into Internet 305. Eventually, it is forwarded to server 320. Server 320 uses a source address specified in the request to send a response to the request. An exemplary device that may be used to implement server 320 is computing device 200 of FIG. 2, configured with appropriate hardware and software.

Illustrative Method of Load Balancing in an Ad Hoc Network

FIG. 4 illustrates a flow chart for load balancing in an ad hoc network, according to one embodiment of the invention. The process begins at block 605 when a node is ready to receive a request for address information associated with a gateway that is providing a communication path between the ad hoc network to another network, such as the Internet. The node that is ready to receive the request may be an ad hoc node in the ad hoc network or the gateway itself.

At block 410, a message is received by the node. For example, referring to FIG. 3, ad hoc node 316 sends a request for address information associated with gateway 310 so that ad hoc node may, for example, inform a forwarding node on ad hoc node 316's home network of an address at which ad hoc node 316 may be reached. This request is sent to ad hoc node 315. Note that ad hoc node 316 may have previously determined that ad hoc node 315 existed by receiving a Hello message. Furthermore, ad hoc node 316 may also have discovered or stored a route to gateway 310 in which ad hoc node 315 is the first node to which a message should be sent from ad hoc node 316. After block 410, processing continues at block 415.

At block 415, a determination is made as to whether the request indicates that only a gateway may answer the request. If the request indicates that only a gateway may answer the request, processing continues at block 425; otherwise, processing continues at block 420. For example, referring to FIG. 3, ad hoc node 315 determines that it does not have address information associated with gateway 310. A request may have a flag set within it that indicates that only a gateway may answer the request. This may be done to ensure that a response does not include outdated information. An ad hoc network is, by its very nature, subject to frequent changes as nodes enter, leave, and are repositioned in the network. At one time, a node may store up-to-date address information associated with a gateway. Later, however, the node's information regarding the gateway may become obsolete or out-dated. Therefore, a node requesting address information may be able to indicate in the request that only the gateway may respond. If the node is a gateway, block 415 may be skipped and processing may continue at block 430 since the gateway's address information is typically stored at least on the gateway.

At block 420, a determination is made as to whether the address information is stored on the node. If it is, then processing continues at block 422; otherwise, processing continues at block 425. For example, referring to FIG. 3, ad hoc node 315 determines that it does not have address information associated with gateway 310. A node may also test to determine whether the address entry it has stored is obsolete. For example, the node may include a time parameter that indicates how long an address should be considered valid before it is out of date. If the time has expired for address information, even if the address information is stored on the node, the node may act as if the address is not stored and may forward the request towards the gateway. After block 430, processing continues at block 430.

At block 422, a determination is made as to whether one or more policies associated with the node allow a response to be made to the requestor. For example, a node may wish to avoid consuming bandwidth or computing resources in responding to a request. A policy associated with the node may indicate that the node may not respond to requests. If a policy associated with the node allows a response to be made to the requestor, processing continues at block 430; otherwise, processing continues at block 424. For example, referring to FIG. 3, ad hoc node 315 searches its policies and determines that it may respond to the request.

At block 424, the request is discarded. For example, referring to FIG. 3, ad hoc node 315 discards the request. After block 424, processing continues at block 440.

At block 425, a request is forwarded towards a gateway. Block 425 is reached if either the request indicates that only a gateway may answer the request or if address information is not stored on the node currently processing the request. For example, referring to FIG. 3, ad hoc node 315 (after determining that it did not have address information associated with gateway 310), forwards the request to ad hoc node 314. After block 425, processing continues at block 440.

At block 430, a response to the request is sent. The response includes address information associated with the gateway. For example, referring to FIG. 3, ad hoc node 314 responds to the request by sending an address associated with gateway 310. As discussed previously, this address may be a partial address (such as a prefix) or full address that uniquely identifies the gateway to a network, such as the Internet. The address may also uniquely identify the ad hoc network. The address allows a node in another network, such as the Internet, to send a message to the gateway and/or ad hoc network. Using the address, an ad hoc node may create an address to identify itself. As mentioned previously, the ad hoc node may then send this address to a forwarding node on the ad hoc node's home network.

The response sent may indicate if a gateway responded to the request. This may be done by setting or not setting a flag in the response. Setting the flag to one value may indicate, for example, that a gateway, such as gateway 310, responded to the request. Setting the flag to another value may indicate that a node other than the gateway responded to the request. This may be useful to determine, for example, the validity of address information in the response. If the response comes from a gateway, it is much more likely to include current address information of the gateway than if it comes from a node other than the gateway. For example, referring to FIG. 3, ad hoc node 314 does not set a flag in the response to indicate that the response is coming from a node other than a gateway. After block 430, processing continues at block 435.

At block 435, address information associated with a gateway is stored. This typically occurs on the requesting node. For example, referring to FIG. 3, ad hoc node 316 stores the address information sent from ad hoc node 314. Among other things, this allows the requesting node to respond to requests for address information associated with a gateway. For example, if another node attempted to join the ad hoc network and sent a request to ad hoc node 316 for address information associated with gateway 310, ad hoc node 316 could respond to the request. This distributes the load of processing requests for address information associated with a gateway to the nodes of an ad hoc network associated with the gateway. A node storing address information associated with a gateway may also store a time after which the address information should be considered obsolete. After this time, the address information may be removed from memory or marked as invalid. The time after which the address information should be considered obsolete may be a function of how many hops the ad hoc node is from the gateway associated with the address information, user configuration, or other factors. After block 435, processing continues at block 440.

At block 440, processing ends or returns to a calling process. At this point, a request for address information associated with a gateway has been received. The request may or may not indicate that only a gateway may answer the request. If the request indicates that only a gateway may answer the request (and the receiving node is not a gateway), then the request has been forwarded towards a gateway. Otherwise, if the address information was not stored on the node, the request also has been forwarded towards a gateway. When the address information is stored on the node, the node has responded to the requesting node and optionally indicates if a gateway responded. The address information has then been stored, typically on at least the requesting node. The process outlined above may be repeated each time a node requests address information associated with a gateway.

In another embodiment of the invention, one or more nodes in the ad hoc network may include policies regarding when they will forward requests sent from other nodes. For example, to conserve battery life, a node may stop forwarding requests to other nodes when battery charge on the node drops below a certain threshold. A node may have certain quality of service (QOS) policies, including processing and queuing, that dictate whether a node forward requests from other nodes. For example, a node may determine that it cannot meet a QOS policy for a request. Based on this determination, the node may be unwilling to act as a forwarding node for the request. A node may have certain bandwidth policies. For example, a node may reserve a certain percentage or an absolute amount of its bandwidth for messages originating from that node. When the node determines that forwarding requests received from other nodes would cut into this percentage, the node may be unwilling to act as a forwarding node for the packets.

Policies may be implemented in a database or some other appropriate data structure residing on or accessible by the node. A policy might indicate that if battery charge is less than fifty percent, the node is no longer willing to act as a forwarding node. A node may be configured such that it does not respond to packets including a request for gateway address information. When a node receives a packet, the node may consult its policies to determine what action it should take, if any. If one or more policies indicate that the node should not process the packet, the node may abstain from responding to the packet. The node may also silently drop the packet and/or the node may send a message to a node that sent or forwarded the packet indicating that the node is unavailable for processing the packet.

It will be recognized that many types of policies may be configured for the processing of packets. Using such policies in an ad hoc network is within the spirit and scope of the present invention.

The various embodiments of the invention may be implemented as a sequence of computer implemented steps or program modules running on a computing system and/or as interconnected machine logic circuits or circuit modules within the computing system. The implementation is a matter of choice dependent on the performance requirements of the computing system implementing the invention. In light of this disclosure, it will be recognized by one skilled in the art that the functions and operation of the various embodiments disclosed may be implemented in software, in firmware, in special purpose digital logic, or any combination thereof without deviating from the spirit or scope of the present invention.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for load balancing in a network, comprising:
(a) employing a first ad hoc node to store address information associated with a gateway that provides a communication path between an ad hoc network and another network;
(b) employing a second ad hoc node to send a request for the address information; and
(c) employing the first ad hoc node to provide the address information in reply to the request.

2. The method of claim 1, further comprising accessing a policy that indicates whether the first ad hoc node will forward another request.

3. The method of claim 2, further comprising dropping the other request when the policy indicates that the first ad hoc node will not forward the other request.

4. The method of claim 1, further comprising advertising the address information by the gateway to at least one ad hoc node that is at least one hop from the gateway.

5. The method of claim 1, wherein the address information includes a route that indicates a path to the gateway.

6. The method of claim 1, wherein the address information includes at least a portion of an address that is associated with the gateway and that identifies the ad hoc network to at least one node in the other network.

7. The method of claim 6, further comprising concatenating a sequence of bits to the portion of the address to obtain an address that identifies the second ad hoc node.

8. The method of claim 7, further comprising sending the address that identifies the second ad hoc node to a forwarding node in the other network.

9. The method of claim 4, further comprising indicating that an hoc node provided the address information.

10. The method of claim 1, wherein the request includes a route discovery request (RREQ) to determine a route to the gateway.

11. The method of claim 1, further comprising:
(a) storing the address information in a computer storage medium accessible by the second ad hoc node; and
(b) in response to a request from a third ad hoc node, accessing a policy associated with the second ad hoc node and if the policy indicates that the second ad hoc node should respond to the request, providing, by the second ad hoc node, the address information.

12. The method of claim 1, further comprising expiring the address information after a time has elapsed from storing the address.

13. A system for load balancing in a network comprising:
(a) a gateway that provides a communication path between an ad hoc network and another network;
(b) a first ad hoc node that is at least one hop away from the gateway and that stores address information that is associated with the gateway; and
(c) a second ad hoc node that performs actions, including sending a request for the address information by sending a message addressed to the gateway, wherein the first ad hoc node provides the address information to the second ad hoc node.

14. The system of claim 13, wherein the second ad hoc node employs at least the first ad hoc node to send a message to the gateway.

15. The system of claim 13, wherein each ad hoc node communicates over a wireless communication medium.

16. The system of claim 13, wherein the gateway communicates with the other network over a non-wireless communication medium and communicates with at least one ad hoc node over a wireless communication medium.

17. The system of claim 13, wherein the address information includes a route that indicates a path to the gateway.

18. The system of claim 13, wherein the address information includes at least a portion of an address associated with the gateway, wherein the portion of the address identifies the ad hoc network to at least one node in the other network.

19. The system of claim 18, wherein the second ad hoc node performs further actions, including concatenating a sequence of bits to the portion of the address to form an address that identifies the second ad hoc node.

20. The system of claim 19, wherein the second ad hoc node performs further actions including sending the address that identifies the second ad hoc node to a forwarding node in the other network.

21. The system of claim 13, wherein the request includes a route discovery request (RREQ) to determine a route to the gateway.

22. A system for load balancing in a network, comprising:
(a) means for providing a communication path between an ad hoc network and another network;
(b) on a first ad hoc node that is at least one hop from the means for providing a communication path, means for storing address information associated with the gateway; and
(c) on a second ad hoc node, means for requesting the address information,
wherein the first ad hoc node provides the second ad hoc node with the address information.
